(19) United States
(12) Patent Application Publication
(10) Pub. No.: US 2002/0099595 A1
(43) Pub. Date: Jul. 25, 2002

(54) Method for handling market surveys with handheld computers

(76) Inventors: Kevin James Kelly, Austin, TX (US); Steven L. Fusco, Austin, TX (US); Rumar Indseth, Austin, TX (US)

Correspondence Address: Wendy K. Buskop, Buskop Law Group, P.C., 1717 St. James Place, Suite 500, Houston, TX, 77056, US

(21) Appl. No.: 09/874,496

(22) Filed: Jun. 5, 2001

Related U.S. Application Data
(60) Provisional application No. 60/262,916, filed on Jan. 19, 2001.

(51) Int. Cl. G06F 17/60

(52) U.S. Cl. 705/10

(57) ABSTRACT

A method for conducting of a survey process.

The present application claims priority to Provisional Patent Application Serial No. 60/262,916 filed with the United States Patent and Trademark Office on Jan. 19, 2001.

### BACKGROUND OF THE INVENTION

The invention generally relates to handheld computers and their relationship to databases and the global communication network. More specifically, the invention relates to the use of a portable computer, optionally, with a communications device to form an easy survey system for use in gathering marketing information and marketplace metrics.

### DESCRIPTION OF RELATED ART

Recent advances in the manufacture and design of integrated circuits have enabled technology producers to provide portable instruments with ever-increasing processing capabilities. Advances in liquid crystal diode displays, stylus based input devices, and handwritten character recognition have also resulted in the availability of palm-sized computers which are also known as personal digital assistants (PDAs), such as the Palm III™ and Palm V™ from Palm, Inc., Santa Clara, Calif.

The primary advantage of these devices is the combination of small size, lightweight, and stored information that can be customized for a particular user. These computers provide functions such as note taking, data retrieval and storage, application program execution, interfacing with external devices, and wireless communications.

The prior art includes accessories that allow a portable computer to become part of a network device. One such accessory is described in U.S. Pat. No. 5,606,594, granted to Register et al. on Feb. 25, 1997, entitled “Communication Accessory and Method of Telecommunicating for a PDA”. A top-edge view of the PDA 100 adapted for insertion into the accessory is provided in FIG. 1A. The PDA 100 has one or more buttons 110 and an electronic link connector 120. As shown in FIG. 1B, the accessory 150 is specially adapted to receive a particular PDA. The PDA 100 can be realizably inserted into the accessory 150. The PDA 100 electronic link connector 120 mates with the accessory 150 electronic link connector 160. The external surfaces of the PDA 100 fit within the retaining wall 170, and concave surface 180 of the accessory 150. The retention ridges 190 are disposed to cover the top and bottom portion of the exterior of the PDA 100 by rotating the rotatable body extensions 195 of the accessory 150.

The accessory 150 allows the PDA to play a part in managing voice communications for the user, and to send and receive data. Similarly, U.S. Pat. No. 5,497,339, granted to Bernard on Mar. 5, 1996 provides for PDA that mounts within a communications device. However, none of the communications devices in the prior art provide methods for software implementation of telephone call processing functions. Also missing from the prior art is the method for storing the phone number and user parameters in the PDA and then deploying the communications device with the PDA/user phone number and user characteristics.

Accordingly, what is needed in the art is a method for entering data, and optionally apparatus for incorporating data onto the global communication network and enterprise back end systems and storage of user parameters in the PDA.

### SUMMARY OF THE INVENTION

The invention provides an information appliance, an appliance that can be connected to the Internet or corporate network specifically where the information appliance stores information corresponding to a particular user and survey information.

The information appliance can be linked to a local area network or even the Internet and be capable of simultaneously sending and receiving data messages, with devices connected to the local area network or the Internet.

The information appliance can be connected to other similar appliances physically through a communications port or using infrared communications, and exchange specially formatted data corresponding to user personalized information, and entered information, commands from the user, and responses including pricing, and product availability status information from the network connected devices.

The handheld device can optionally perform network communications according to user specified settings and enables the information appliance to assume the user specific information appliance identification. The information appliance is typically a portable computer and in some embodiments is a palm-sized computer which can be connected, either by direct physical connection, infrared or Ethernet to a communication system, or the Internet.

A first aspect of the invention provides a handheld computer comprising a communications link capable of connecting to network connected devices. The portable computer includes a port for connecting to the Internet, a LAN or even a telephone, a memory storing user information corresponding to a user; and processing resources adapted to exchange data with the network or even a non-networked database.

The exchange of the data enables a portable or handheld computer to analyze content on the shelves of stores of selected product, including the dates the product was manufactured to enable a distributor or manufacturer to optimize deliveries to a store.

In some embodiments, the portable computer comprises a palm-sized handheld computer and user information may be formatted according to an applications layer protocol. In the preferred embodiment, check boxes can be used which can be actuated by a stylus on the handheld computer.

In some embodiments, the portable computer may include processing resources for user interface support of video data. In some embodiments, the portable computer includes processing resources for user interface support of video data, video data decoding, and video display. In some embodiments, the portable computer may include processing resources for user interface support of video data, video data decoding, video display, and video camera image data.

A second aspect of the invention provides a method for transmitting data from a portable computer to a database. This may be accomplished using a telephone or an Internet connection or other LAN or wireless connection.

In some embodiments, prior to connecting the portable computer with the database, the portable computer stores user information. The user information can include an identification corresponding to the portable computer, user access parameters, and user characteristics corresponding to the database parameters.

In some embodiments, the handheld computer is connected to a router, which is connected to an Internet source. Communications between the router and the computer are formatted according to packet based network application protocols.

A third aspect of the invention includes a method for exchanging data messages between a handheld computer and devices connected to a network. The portable computer may be enabled such that it exchanges operating parameters data with a network-connected device.

In some embodiments, the method includes, prior to connecting the portable computer with the network, the portable computer storing user information. The operating parameter data comprises the user information. The user information comprises an identification corresponding to the portable computer and user access parameters.

In some embodiments, the portable computer includes a display providing user interface graphic elements corresponding to a user interface enabling the user to input data supplementing the user information provided to the Internet.

In some embodiments, the portable computer includes processing resources for Internet access. The processing resources for Internet access can include Internet applications, transmission control software, and Internet protocol software. Alternatively, the processing resources for Internet access can include Internet display applications and display/user input transfer software.

In some embodiments, the portable computer may include processing resources for user interface support of video data. The processing resources for user interface support of video data can include video data decoding, and video display. Alternatively, the processing resources for user interface support of video data, video data decoding, video display, and video camera image data.

### BRIEF DESCRIPTION OF THE DRAWINGS

FIG. 1 is the initial screen of the invention;

FIG. 2 shows the screen that allows the user to select a geographic market;

FIG. 3 shows the screen that allows the user to select the specific store being visited in the selected market;

FIG. 4 shows the screen that allows the user to select the specific package on display;

FIG. 5 represents the screen that allows the user to enter the price of the items on display and the quantity of each brand or type of item;

FIG. 6 demonstrates a screen prompting the user if there are additional displays in the store that should be entered into the program; and

FIG. 7 shows a screen to capture free form notes from the user.

### DETAILED DESCRIPTION OF THE INVENTION

Handheld computers have had wide reception in the marketplace. The present invention is a software program that works with certain handheld computers. Particular handheld computers contemplated for use in the present invention include the Palm III™, Palm IIIx™, Palm IIIxe™, Palm IIIe™, Palm IIIc™, Palm V™, Palm Vx™, Palm VII™, Palm VIIx™, IBM Workpad™, TRGPro, Symbol SPT1500 and any other Palm OS™ powered handheld computer. A need has long existed for a handheld computer capable of gathering market data in a retail segment, such as six packs of cola in a convenience store, and tracking the product offerings, not only on a store-by-store basis, but also on a regional or even national basis.

The portable computer is referred to herein as an information appliance that can be any portable device capable of storing user information and exchanging information with a network connected appliance.

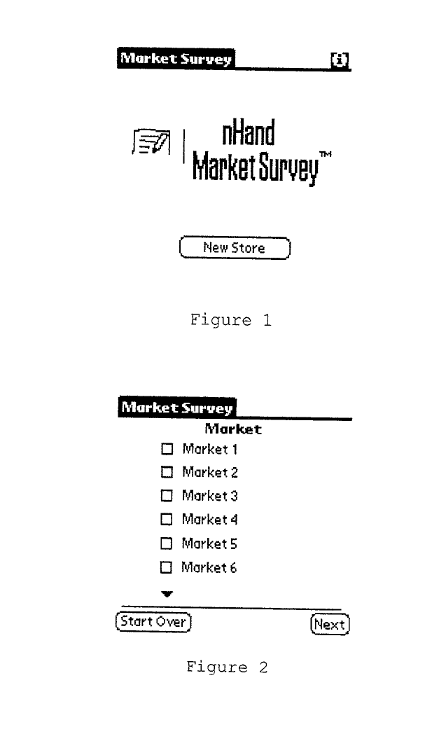

The user interface in the handheld computer typically comprises a display, however any device, or element thereof, that can provide sensory cues adapted for perception by the user can be used as a user interface according to the invention. The user can provide inputs for the display by tapping a user interface graphic element image on the screen with a stylus, pressing a button or key on the information appliance or by any other means known in the art. Details of the display and certain user interface graphical elements and user inputs related thereto for some embodiments are conventional, however, typical screens are depicted as FIGS. 1, 2, 3, 4, and 5.

The present invention generates profiles of product offerings across geographies, with comparative data on competitors being available. The process thoroughly automates previous inventory taking manual data recordation systems, however, this electronic version adds instantaneous data on pricing, and quantity, which can immediately generate orders for the manufacturer or distributor.

The invention relates to a method of conducting of a survey process which comprises a plurality of steps, including defining a sequence of predetermined survey process steps to be used by a surveyor; in a first step, using a handheld computer that generates predetermined first prompts to guide the surveyor to enter reference data corresponding to the first prompts on the handheld computer; storing the entered reference data in the handheld computer using a handheld first database having a structure which is at least partially predetermined; in a second step, generating second prompts to guide the surveyor to enter proposal data corresponding to the second prompts, and determining requirements for the retrieval of data from the first database; automatically retrieving selected reference data from the first database, at least partially according to requirements of the second step; and storing the selected reference data and the proposal data in a second database for use in at least one further step of the method; and generating a first report including at least a portion of the selected reference data and the proposal data.

In a preferred embodiment, it is contemplated that the first prompts relate for a store survey, to product size, product location, product contents and combinations thereof.

Additionally, the first database stores the entered reference data in a hierarchical tree structure. The tree structure for the software is contemplated to have a plurality of user-defined headings. The first prompts include prompts for information on geographic data, retailer name, buyer contact information, and size of the retailer.

A first report can be generated, including at least a portion of the reference data and the input information is compiled as a report on sales and provides a projection for future sales.

The second prompts are selected from prompts for information on the store location, store type and combinations thereof. The second prompts can request information on the basic product details, the distributor, the product costs, the amount of inventory, details of the buyer, assumptions on sales.

The step of generating the second prompts comprises the step of guiding the surveyor to enter data corresponding to the second prompts, with the data being stored in the second database.

In a third step, third prompts can be generated to guide the surveyor to enter result data corresponding to the third prompts and storing the entered result data in the second database together with data stored previously in the second database. These third prompts include prompts for information on survey results corresponding to headings in the second database.

In a fourth step, fourth prompts can be generated to guide the surveyor to select and/or enter report data corresponding to the fourth prompts for inclusion in a survey report. A survey report comprising report data and data selected from the database, the survey report being compiled in a format which is at least partially predetermined by the customer of the database.

This invention also relates to a software package for use in assisting in the conducting of a survey which comprises a plurality of steps, the software comprising: a reference database module arranged to generate predetermined first prompts to guide the surveyor to enter reference data corresponding to the first prompts, and to store the entered reference data in a first database having a structure which is at least partially predetermined; a work database module arranged to generate predetermined second prompts to guide the surveyor to enter proposal data corresponding to the second prompts, to automatically retrieve selected reference data from the first database and to store the selected reference data and the proposal data in a second database for re-use; and an interface module arranged to extract selected data from the second database and to generate a first report comprising the selected data and the proposal data, so that the first report has a format which is at least partially determined by the structure of the second database.

The software program operates most preferably on at least a Palm OS 3.0 and above. The program preferably allows for the addition of selected reference data.

In the most preferred embodiment, the program captures the following information for upload to a personal computer (PC) or enterprise database for review and analysis:

Screen 1: Market—by city or region

Screen 2: Stores in the selected city or geographic region

Screen 3: Size of packages on display in the specific store being inventoried

Screen 4: Brands, which should be at the store based on size of the packages present

Screen 5: Queries as to whether or not other displays in the store exist

Screen 6: Notes on the process.

It is particularly significant that the survey program permits each screen to either “start over” or go to the “next screen or go back to the “previous screen.” Also, it is contemplated to be within the scope of the invention that Screen 5 can go back to Screen 3 followed by screen 4, when there are other displays in the same store.

Additionally, the following information is contemplated as imputable into the program for future situations:

Regional sales manager (for products in the store being surveyed)

Date of survey

Time of survey

Bottler (or actual plant manufacturer) of products being surveyed

Account type—blanket accounts, one time accounts or other accounts.

Account number, or account numbers (if more than one account is in a store or location)

Display type—end cap, shelf or freestanding display are typical picks that can be programmed into the unit.

Brand name (such as the Brand of the product, with each individual product being listed)

Quantity—which can feature a variety of quantities

Price—the wholesale price and the retail price can be programmed into the unit to determine the profit margin for the product.

Notes—this section is designed to have free form notes that can accommodate a variety of information, such as whether product on the adjacent shelf is of the same color, or has similar trademarks.

Although use on the handheld computer is the most preferred, portions of the program could be run on a PC. If a PC is used, it is contemplated that the program will synchronize reference information bi-directionally with the handheld software. The program will synchronize market survey information in a unidirectional manner from the handheld software into a Microsoft Excel readable format. The program will allow a user to interface to maintain the reference information.

The LAN link can be through a digital subscriber line (DSL), a twisted-pair cable, an integrated services digital network (ISDN) link, or any other link that supports packet switched communications with a LAN, including Internet Protocol (IP)/Transmission Control Protocol (TCP) communications using an Ethernet. The gateway server can be connected to regional, national, and global services across wide area network links to public networks (PSTN), and other switched circuit networks (SCNs). Broadband distribution channels, wireless networks, restricted access government and corporate networks, or any other communications network capable of transmitting data formatted for SCNs or packet based networks (PBNs) can be used with the handheld computer.

Data can be downloaded from the handheld through a variety of methods, the most preferred method is a synchronization process such as the Palm HotSync® process.

During the synchronization process, data collected on the handheld computer is transferred to a personal computer where it is then incorporated into a Microsoft Excel spreadsheet or other database or data store for analysis.

Within the scope of the present invention, it is contemplated that the method would provide a photo capture feature, to capture pictures of product on the shelves and displays in stores using a Kodak PalmPix camera, which attaches into a handheld computer, or another similar digital camera which can be tied into the handheld computer and synced into the database inputs. The integration is important to tracking this information.

It is contemplated that the market survey handheld computer method can be used to track specific information about a product, such as the manufacturing codes, date of manufacture, and plant of manufacture. This tracking of codes taken from the bottoms of products enables a user of the unique method to evaluate the efficiencies in the supply chains of the distributors. It is also conceived that such data capture could occur through the use of a barcode scanning device such as a Symbol SPT 1500 handheld device.

Additionally, it is contemplated that the invention could capture citation information using audio (i.e. voice) and video (e.g. still photos, video) data capture. Furthermore, it is contemplated that the invention could operate on additional handheld devices other than those based on Palm OS™ such as Microsoft Pocket PC, for example.

FIG. 1 is the initial screen of the invention. This screen has blocks for the application logo, an “i” icon which leads to the application's “about” screen, a “new store” button to start a market survey for a new store, and a hidden “preferences” button. The preferences button is hidden behind the application logo and leads to a setup screen that allows the user to configure user-specific information such as the user's name, employee identification number and preferences to use pop-up keypads for data entry.

FIG. 2 shows the screen that allows the user to select a geographic market; all data captured in the rest of the market survey will be for the selected market and all data displayed will only be for the particular market selected here. The screen has six check boxes that represent the six most often utilized markets. Since the system can support more than six markets, however, a drop list below the check boxes allows the user to select any one of the markets in the system even if it is not one of the six most frequently used. Example geographical markets might include “Austin”, “Dallas”, “New York”, “San Antonio”, “Las Vegas” or any other geographically delineated market. A “start over” button allows the user to begin a new market survey data capture session; a “next” button allows the user to navigate to the next screen in the data capture process.

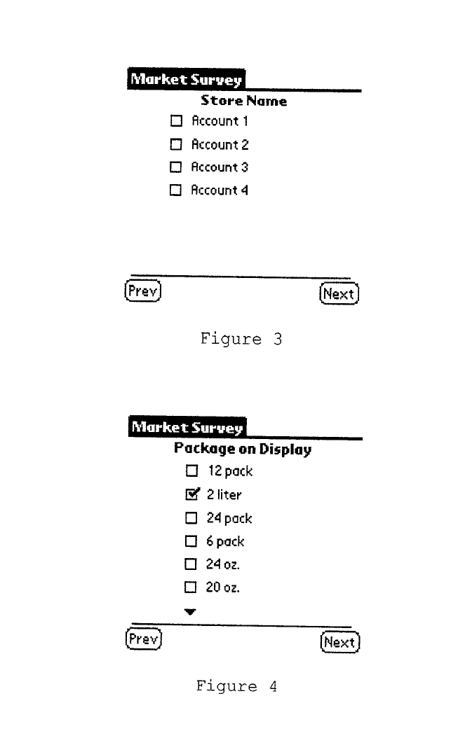

FIG. 3 shows the screen that allows the user to select the specific store being visited in the selected market. Stores listed on this screen are only stores that are in the geographic market selected previously (FIG. 2). The screen has six check boxes that represent the six most often utilized stores in the selected market. Since the system can support more than six stores, however, a drop list below the check boxes allows the user to select any one of the stores in the system for the selected market even if it is not one of the six most frequently used. Example stores might include “H.E.B.”, “Wal-Mart”, “Walgreen”, “Randall's”, “Tom Thumb” or any other retail store. A “prev”, or “previous”, button allows the user to navigate to the previous screen in the data capture process; a “next” button allows the user to navigate to the next screen in the data capture process.

FIG. 4 shows the screen that allows the user to select the specific package on display being documented in the selected store. Packages listed on this screen are only packages that are in the store selected previously (FIG. 3). The screen has six check boxes that represent the six most often utilized packages in the selected store. Since the system can support more than six packages, however, a drop list below the check boxes allows the user to select any one of the packages in the system for the selected store even if it is not one of the six most frequently used. Example packages might include “12 pack”, “2 liter”, “24 pack”, “6 pack”, “24 ounce”, “20 ounce” or any other size or type of packaging. A “prev”, or “previous”, button allows the user to navigate to the previous screen in the data capture process; a “next” button allows the user to navigate to the next screen in the data capture process.

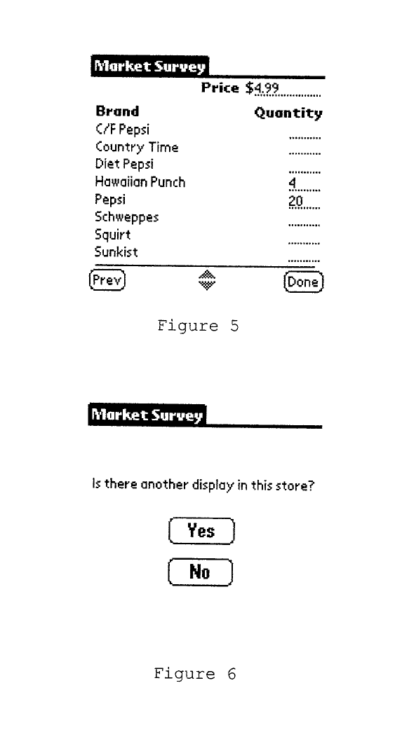

FIG. 5 represents the screen that allows the user to enter the price of the items on display and the quantity of each brand or type of item. A field captures the price of the item using any conventional data capture mechanism or a pop up keypad; then, for each brand or type of item that is available in the size of packaging selected previously (FIG. 4) the user enters the quantity on display. If there are more than eight brands available, the user may scroll up and down the list using up and down arrows at the bottom of the screen. Example brands or types of product might include “cola”, “tea”, “coffee” or any other brand or type of product. A “prev”, or “previous”, button allows the user to navigate to the previous screen in the data capture process; a “done” button allows the user to navigate to the next screen in the data capture process.

FIG. 6 demonstrates a screen prompting the user if there are additional displays in the store that should be entered into the program. A “yes” button and “no” button are visible on this screen. If the user selects “yes”, the program navigates back to the screen requesting the type of package that is on display (FIG. 4) for the new display. However, if the user selects “no”, the program moves to the next screen in the data capture process.

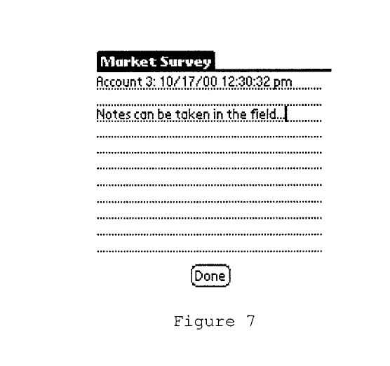

FIG. 7 shows a screen to capture free form notes from the user. The note contains some default information including the store that the market surveys were completed for (selected in FIG. 3) and the date and time that the market survey was completed. The user may use any conventional data capture mechanism or a pop up keypad to enter free form notes. The “done” button completes the market survey, queues it for upload into the corporate database system and returns the user to the initial screen (FIG. 1).

While specific embodiments of the invention have been shown and described in detail to illustrate the application of the inventive principles, it will be understood that the invention may be embodied otherwise without departing from such principles.

Other uses of this program would be for any type of retail distributor overseeing product distribution. It could also be used for inventory control to capture the quantity of a particular product on hand. Additionally, it could be used for logistics and facilities management to determine which location a specific quantity of product would be located at.

Having thus described a preferred embodiment of the data communication system, it should be apparent to those skilled in the art that certain advantages of the described system have been achieved. It should also be appreciated that various modifications, adaptations, and alternative embodiments thereof may be made within the scope and spirit of the present invention. The invention is further defined by the following claims.

What is claimed is:

1. A method of conducting of a survey process which comprises a plurality of steps, the method comprising:
defining a sequence of predetermined survey process steps to be used by a surveyor; in a first step, using a handheld computer that generates predetermined first prompts to guide the surveyor to enter reference data corresponding to the first prompts on the handheld computer;
storing the entered reference data in the handheld computer using a handheld first database having a structure which is at least partially predetermined;
in a second step, generating second prompts to guide the surveyor to enter proposal data corresponding to the second prompts, and determining requirements for the retrieval of data from the first database;
automatically retrieving selected reference data from the first database, at least partially according to requirements of the second step; and
storing the selected reference data and the proposal data in a second database for use in at least one further step of the method; and generating a first report including at least a portion of the selected reference data and the proposal data.

2. The method according to claim 1, wherein the first prompts relate for a store survey, to product size, product location, product contents and combinations thereof.

3. The method according to claim 1, wherein the first database stores the entered reference data in a hierarchical tree structure.

4. The method according to claim 3, wherein the tree structure includes a plurality of user-defined headings.

5. The method according to claim 1, wherein the first prompts include prompts for information on geographic data, retailer name, buyer contact information, and size of the retailer.

6. The method according to claim 1, the first report which is generated, including at least a portion of the reference data and the input information is compiled as a report on sales and provides a projection for future sales.

7. The method according to claim 6, wherein the second prompts are selected from prompts for information on the store location, store type and combinations thereof.

8. The method according to claim 7, wherein the second prompts are selected from prompts for information on the basic product details, the distributor, the product costs, the amount of inventory, details of the buyer, assumptions on sales.

9. The method according to claim 1, wherein the step of generating the second prompts comprises the step of guiding the surveyor to enter data corresponding to the second prompts, with the data being stored in the second database.

10. A method according to claim 1, including, in a third step, generating third prompts to guide the surveyor to enter result data corresponding to the third prompts and storing the entered result data in the second database together with data stored previously in the second database.

11. A method according to claim 10, wherein the third prompts include prompts for information on survey results corresponding to headings in the second database.

12. A method according to claim 10, including, in a fourth step, generating fourth prompts to guide the surveyor to select and/or enter report data corresponding to the fourth prompts for inclusion in a survey report.

13. The method according to claim 12, including generating a survey report comprising report data and data selected from the database, the survey report being compiled in a format which is at least partially predetermined by the customer of the database.

14. A software package for use in assisting in the conducting of a survey which comprises a plurality of steps, the software comprising:
a reference database module arranged to generate predetermined first prompts to guide the surveyor to enter reference data corresponding to the first prompts, and to store the entered reference data in a first database having a structure which is at least partially predetermined;
a work database module arranged to generate predetermined second prompts to guide the surveyor to enter proposal data corresponding to the second prompts, to automatically retrieve selected reference data from the first database and to store the selected reference data and the proposal data in a second database for re-use; and an interface module arranged to extract selected data from the second database and to generate a first report comprising the selected data and the proposal data, so that the first report has a format which is at least partially determined by the structure of the second database.
